(19) United States
(12) Patent Application Publication
(10) Pub. No.: US 2021/0076706 A1
(43) Pub. Date: Mar. 18, 2021

(54) PET FOOD PRODUCT COMPRISING DENATURED ZEIN PROTEIN

(71) Applicant: MARS, INCORPORATED, McLean, VA (US)

(72) Inventors: Maik Michael Herrmann, Verden (DE); Holger Schumacher, Verden (DE); Seronei Chelulei Cheison, Verden (DE); Johannes Paul Schlebusch, Verden (DE)

(73) Assignee: MARS, INCORPORATED, McLean, VA (US)

(21) Appl. No.: 16/772,694

(22) PCT Filed: Dec. 13, 2018
(86) PCT No.: PCT/EP2018/084708

§ 371 Date: Jun. 12, 2020

(30) Foreign Application Priority Data
Dec. 14, 2017 (GB) 1720900.8

(51) Int. Cl. A23K 50/48; A23K 10/20; A23K 20/147; A23K 40/00

(52) U.S. Cl. CPC A23K 50/48; A23K 40/00; A23K 20/147; A23K 10/20

(57) ABSTRACT

A process for the preparation of a food product, particularly a pet food product, comprising zein protein and particularly also comprising animal protein, said process comprising the steps of: (i) providing a composition comprising zein protein; (ii) treating the composition from step (i) to denature said zein protein to provide a composition comprising denatured zein protein; and (iii) mixing said composition comprising denatured zein protein with other ingredients of said food product, particularly animal protein.

The invention relates to the use of denatured zein protein in pet food products, to the pet food products themselves and processes for the preparation of the pet food products.

Pet foods have long been manufactured from animal by-products and non-animal derived ingredients in order to prepare high quality food that provides the pet with the required nutrient profile without competing with the human food demand for meat. As the global population increases the global demand for high protein foods including meat is expected to increase, so an increasing need for pet foods prepared from alternative proteins while meeting the nutritional needs of pets is expected. It would be desirable to meet these needs without increasing (and preferably whilst reducing) the environmental impact, particularly in respect of deforestation and climate change, of growing populations. There is, therefore, an increasing need for pet foods to be manufactured from more sustainable proteins.

Replacing meat protein with alternative proteins in pet foods requires a number of issues to be addressed, e.g. the products must have integrity, they must be palatable to the pet and must have textures and smells that are desirable to both the pet and the pet owner. It is also preferable for new analogue products to be prepared and processed using existing processing assets, and using recipes which are otherwise the same as, or similar to, existing products.

There is therefore a particular need for pet foods incorporating a higher amount of non-meat protein while maintaining or improving high levels of nutrition and product quality.

Pet food is commonly categorized on the basis of its moisture content:

(1) Dry or low moisture content products (defined herein as exhibiting less than 20 wt % moisture content). These products typically combine high nutritional content with convenience.
(2) Semi-moist or semi-dry or soft dry or intermediate or medium moisture content products (defined herein as exhibiting from 20 to 50 wt % moisture content).
(3) Wet or high moisture content products (defined herein as exhibiting greater than 50 wt % moisture content). These products are generally most palatable to pets.

The present invention is particularly directed towards wet pet food, of which there are two main types.

The first type of wet pet food product is known as ‘pate’ or ‘loaf’ and is typically prepared by processing a mixture of edible components under heat to produce a homogeneous semi-solid mass that is structured using hydrocolloids or by heat-coagulated protein. This homogeneous mass is usually packaged into single serve or multi serve packaging which is then sealed and sterilised. Upon packing, the homogeneous mass assumes the shape of the container.

The second type of wet pet food product is known as ‘chunk-in-gravy’, ‘chunk-in-jelly’ or ‘chunk-in-mousse’, depending on the nature of the sauce component, and these types of products are referred to generically herein as ‘chunk-in-sauce’ products. The present invention is particularly directed to ‘chunk-in-sauce’ wet pet food products. The chunks comprise meat pieces or restructured meat pieces. Restructured meat pieces may suitably be prepared by making a meat emulsion containing a heat-settable component, and by applying thermal energy to ‘set’ the emulsion and allowing it to assume the desired shape. The product pieces are combined with a sauce (e.g. gravy, jelly or mousse) in single-serve or multi-serve packaging which is then sealed and sterilised.

Many wet pet food products contain a significant amount of meat and animal by-products. Reconstitution of animal by-products into aesthetically pleasing restructured or reconstituted meat chunks is a key feature of most wet pet food products. A widely used technology relies on the heat setting of meat proteins and the addition of heat-settable binders. Soluble meat proteins coagulate and create a strong matrix when heated above 80° C. Additives such as dried animal blood plasma and other heat-setting binders are typically included to give sufficient chunk strength, particularly such that the matrix is able to withstand the retort/sterilisation process described hereinbelow.

A particularly common protein source in pet foods, particularly wet pet foods, are the functional organs of an animal such as liver, kidney, spleen, lung, etc., of which liver is particularly common in a wide range of pet food products. Such functional organs may be, for instance chicken, porcine or bovine in origin. Such functional organs are typically used in tandem with other animal-derived protein sources. For the reasons noted above, it would be desirable to provide a partial or complete replacement (preferably a complete replacement) for such functional animal organs in reconstituted meat chunks and pet food products (particularly wet pet foods), particularly wherein the physical characteristics of the reconstituted meat chunks and said pet food products are maintained or improved.

One physical characteristic of the reconstituted meat chunks which is of particular importance is chunk strength (resilience) or hardness. A chunk which is too weak or too soft is more easily broken or fragmented, which undesirably reduces the stability and cohesiveness of the chunk. In addition, this can result in small pieces or “fines” (solid material with a longest dimension of no more than 3 mm) being present in the product, which is undesirable for a number of reasons. For instance, fines tend to migrate to the surface of the product and are visible to the consumer (i.e. the pet owner) upon opening of the packaged product, which generates an undesirable perception of a lack of freshness or quality. Fines also cause blockage of filling equipment leading to uncontrolled variability in product quantities and rejection by automated weighing systems. The chunk should also be sufficiently strong and stable so that it is able to withstand the retort/sterilisation steps of the packaging process.

A further consideration for replacement products is that they should desirably be processable using existing equipment. For instance, the reconstituted meat chunks should desirably not exhibit a tack or stickiness which would cause the chunks to stick to the conveyors used to transport them during manufacture, thereby resulting in the need to clean and un-block the conveyors causing undesirable equipment down-time. Thus, any analogue product using replacement ingredients should not exhibit increased tack or stickiness, relative to existing products (in particular, existing products which contain functional organs of an animal, such as liver).

In addition, the pet food product must exhibit a texture and smell such that it is palatable to the pet. Thus, any analogue product using replacement ingredients should at least maintain the palatability of existing products (in particular, existing products which contain functional organs of an animal, such as liver).

It is an object of this invention to address one or more of the afore-mentioned problems.

According to a first aspect of the invention, there is provided a process for the preparation of a food product comprising zein protein, said process comprising the steps of:
(i) providing a composition comprising zein protein;
(ii) treating the composition from step (i) to denature said zein protein to provide a composition comprising denatured zein protein; and
(iii) mixing said composition comprising denatured zein protein with other ingredients of said food product.

The food product is preferably a pet food product, preferably a wet pet food product. The food product preferably comprises zein protein and further comprises animal protein. The food product is preferably a reconstituted animal material comprising zein protein and further comprising animal protein.

Zein protein is a class of prolamine protein found in maize (corn). It is hydrophobic and insoluble in water. Zein protein has long been known as an ingredient in processed foods, and has been used as a filler in pet food products. In its native form, however, zein protein lacks functionality and is unable to form a retort-stable gel. Thus, a barrier to its use as a protein source in food products is its low gelling ability and poor network formation with animal proteins, particularly when included in meat emulsions. Hitherto, zein protein has not been a viable protein source because of its inability to provide sterilisation-stable networks with animal proteins in a meat emulsion upon heating. Thus, there is a difficulty in combining zein protein with animal protein whilst maintaining the important characteristics of the food product, particularly rheology, texture, strength and palatability. The present inventors have unexpectedly found a way to harness and utilise the potential of zein protein as a protein source in food products, particularly pet food products, in which the protein fraction also comprises animal protein, whilst simultaneously maintaining the quality of the food product, and using otherwise conventional recipes and processes. The inventors have found that denatured zein protein exhibits excellent binding ability, in particular the ability to connect and form a network with other proteins, particularly animal proteins, encapsulating and/or binding the water and fat present in the composition of the food product. Unexpectedly, the denatured zein protein also exhibits excellent sterilisation-stable gelling properties.

Thus, the food product described herein preferably comprises a protein fraction comprising denatured zein protein and further comprising animal protein. Preferably, the protein fraction of the food product does not comprise animal protein derived from functional organs of an animal, particularly liver. Thus, preferably the food product does not comprise functional organs of an animal, particularly liver.

Advantageously, the food product produced by the process of the present invention preferably comprises a blended proteinaceous matrix or network of animal protein and denatured zein protein. The animal protein may also be denatured. The blended proteinaceous matrix or network is preferably essentially homogeneous, meaning that the zein and animal proteins are intimately mixed and bound.

As used herein, the term “animal protein” means protein derived from the muscle, organs, tissues, tendons and/or bone of an animal. Animal proteins include any protein of animal origin (including vertebrate and invertebrate animals), e.g. proteins derived from mammals, fowl, fish and insects. Examples of suitable animal proteins include those derived from chicken, turkey, beef, lamb, pork, venison, buffalo, duck, kangaroo, shell fish, crustaceans, salmon, tuna, whitefish and the like. Animal protein is preferably from a vertebrate animal, including mammals, fowl and fish. The animal protein may be ground animal material, said ground animal material preferably being selected from meat and animal by-products and combinations thereof. At least a portion of the animal protein may be protein derived from muscle, organs, tissues and tendons, but preferably not protein derived from functional organs of an animal. The ground animal material may contain at least 50 wt %, or at least 70 wt % or at least 85 wt % of animal by-product. Animal by-products are the entire bodies or parts of bodies of animals or products of animal origin not intended for human consumption; such by-products are conventional in the art for the manufacture of ground animal material suitable for use in pet food products. Animal tissue may comprise animal blood plasma, preferably dried animal blood plasma, which is a protein source conventionally used in the preparation of pet food products. Preferred animal blood plasma may be porcine or bovine blood plasma or mixtures thereof. It will be appreciated that the term “animal protein” excludes materials produced and secreted externally by a live animal, such as milk, eggs and the like.

As used herein, the term “functional organs of an animal” refers to organs such as liver, kidney, spleen, lung, etc.

In the process of the present invention, the zein protein is denatured prior to its combination with the animal protein.

The composition comprising zein protein of step (i) is preferably in powder form.

The denatured zein protein is preferably prepared by the application of mechanical energy, particularly in an extrusion process. Thus, treating step (ii) preferably comprises the application of mechanical energy to denature said zein protein. Treating step (ii) preferably comprises passing said composition comprising zein protein through a twin-screw extruder.

The denatured zein protein is preferably prepared by the application of thermal energy, particularly in an extrusion process. Treating step (ii) is preferably conducted at a temperature in the range of from about 100 to about 160° C., preferably from about 120 to about 140° C.

Prior to or during the treating step (ii), an aqueous medium is preferably added to the composition comprising zein protein, preferably in amount such that the weight ratio of said composition to said aqueous medium is in the range of from about 70:30 to about 60:40. Preferably, the composition comprising zein protein defined in step (i) (preferably in powder form) and the aqueous medium are fed to an extruder in separate streams, and the feed rates adjusted in accordance with pre-determined ratios.

Preferably the aqueous medium is water.

In a preferred embodiment, the treating step (ii) comprises adjusting the pH of the composition to a pH of less than about 8.00, preferably no more than 7.00, preferably less than about 7.00, and preferably in the range of from 4.50 to less than 7.00, preferably at least about 5.00, preferably at least about 6.00. Any suitable acid or base may be used to adjust the pH, typically HCl and/or NaOH, preferably NaOH.

In a particularly preferred embodiment, said aqueous medium in the treating step (ii) is an aqueous NaOH solution, such that the pH of the composition is from about 5.00 to about 7.00.

Prior to or during the treating step (ii), one or more water-dispersible material(s) is preferably added to the composition comprising zein protein, preferably in an amount such that the weight ratio of said zein protein to said one or more water-dispersible material(s) is from about 10:90 to about 95:5, preferably from about 30:70 to about 92:8, preferably from about 30:70 to about 90:10, and preferably in the range of from about 40:60 to about 60:40. The water-dispersible material functions to increase the interaction of the hydrophobic zein protein with water during treating step (ii).

As used herein, the term “water-dispersible material” refers to a material that has greater hydrophilicity and/or water dispersibility than zein protein, and preferably has at least greater water-dispersibility than zein protein. The water dispersibility of proteins may be measured by any suitable technique (for instance, the protein dispersibility index (PDI) referred to by G. Reinitz (1984) “Protein Dispersibility Index (PDI) as a Quality Control Measure for Soy Flour Used in Brown Trout Starter Feed”, The Progressive Fish-Culturist, 46:3, 161-164).

Such “water-dispersible materials” are preferably selected from proteins, particularly gelatin, albumin, casein, whey (including whey concentrate and whey isolate) and plant-derived proteins such as sunflower protein or rapeseed protein, or concentrates or isolates thereof, and preferably wherein said material is selected from gelatin, casein and whey, particularly from whey.

Such “water-dispersible materials” may also be selected from hydrocolloids or gums, which are typically hydrophilic polymers and may be of vegetable, animal, microbial or synthetic origin. These materials generally contain many hydroxyl groups. Examples include, for instance, gum Arabic, carboxymethylcellulose, guar gum and xanthan gum and the like.

Preferably, an aqueous medium and a water-dispersible material are added to the composition comprising zein protein. The water-dispersible material may be added to the composition comprising zein protein before, during or after the addition of an aqueous medium to the zein protein, but is typically added before the addition of said aqueous medium. In embodiments wherein an aqueous medium and a water-dispersible material are added to the composition comprising zein protein, the product of treating step (ii) is preferably a hydrated proteinaceous blend of said water-dispersible material and denatured zein protein, i.e. wherein the proteinaceous blend comprises the aqueous medium dispersed or otherwise bound therein. The presence of the aqueous medium promotes the texturisation of the zein protein, and also assists in the transfer of thermal and/or mechanical energy to the ingredients, while minimising or eliminating thermal degradation of the ingredients.

During denaturing in step (ii), the hydrogen bonding and other electrostatic interactions which normally retain the protein in its natural molecular conformation start to break, and the protein unfolds. However, when in their unfolded form, the peptide chains are free to react with each other, resulting in polymerisation (for instance via the formation of hydrophobic interactions and disulfide bonds) and re-forming of hydrogen bonds, typically to produce a cross-linked three-dimensional network, and hence the chain entanglement and aggregation which is manifested as gelation. Uncontrolled denaturing results in a gelled material which remains incompatible with animal protein. The present inventors have surprisingly found that zein protein denatured, and particularly having formed a micro-particulate morphology, in accordance with the process of the present invention is able to interact subsequently with animal protein to form a homogeneous or blended matrix without detriment to characteristics such as the rheology, strength, texture and sensory attributes of the composition.

In the process of the invention, treating step (ii) avoids or substantially avoids the formation of gelled zein protein during the performance of said step (ii). The resulting denatured zein protein is unfolded but polymerisation, entanglement, aggregation and gelation of the peptide chains have been avoided or reduced.

The denatured zein protein in the composition provided by step (ii) is preferably in particulate form, preferably in micro-particulate form. Preferably, the denatured zein protein provided by step (ii) is in particulate form such that the particles are non-aggregated or substantially non-aggregated.

The particle size of the denatured zein protein in the composition provided by step (ii) is preferably no greater than, and preferably smaller than, the particle size of the native zein protein from which it is derived.

As used herein, the term “micro-particulate” form preferably means a particle size of no more than about 1000 μm, preferably no more than about 500 μm, preferably no more than about 350 μm, preferably no more than about 200 μm, and preferably at least about 75 μm.

As used herein, the term “particle size” refers to the volume distributed median particle diameter (equivalent spherical diameter corresponding to 50% of the volume of all the particles, read on the cumulative distribution curve relating volume % to the diameter of the particles—often referred to as the “D(v,50)” value). The median particle size may be determined by plotting a cumulative distribution curve representing the percentage of particle volume below chosen particle sizes and measuring the 50th percentile.

The particle size distribution is preferably such that the volume distributed D(v,90) value (i.e. equivalent spherical diameter corresponding to 90% of the volume of all the particles, read on the cumulative distribution curve relating volume % to the diameter of the particles) is no more than 750 μm, preferably no more than 650 μm, preferably no more than 550 μm.

The resulting denatured zein protein preferably has a degree of denaturation of at least about 75%, preferably at least about 80%, preferably at least about 85%, preferably at least about 90%, preferably at least about 95%, and preferably at least about 98%. The degree of denaturation is preferably measured by differential scanning calorimetry (DSC) as described herein. It will be appreciated that the percentage value of the degree of denaturation is the proportion of denatured protein compared to the native protein in the original sample.

The composition comprising the denatured zein protein is then mixed with the other ingredients of the food product, according to step (iii) of the process of the present invention. In one embodiment, steps (i) to (iii) of the process of the invention defined herein represent a close-coupled or semi-continuous or continuous process. In an alternative embodiment, between steps (ii) and (iii) said composition comprising denatured zein protein is dried, collected and stored for subsequent use in said process for the preparation of a food product.

Preferably, step (iii) of the process of the invention comprises the step of mixing the denatured zein protein with animal protein. Other ingredients are preferably selected from those conventionally used in the manufacture of reconstituted meat and pet food products (particularly wet pet food products), such as fat(s), antioxidant(s), carbohydrate source(s), fibre source(s), additional source(s) of protein (including vegetable protein), seasoning, colorant(s), flavouring(s), mineral(s), preservative(s), vitamin(s), emulsifier(s), farinaceous material(s) and combinations thereof.

The ingredients may be mixed using any suitable equipment conventional in the art, for instance a heated extruder or a jacketed paddle mixer, optionally combining the ingredients with water.

Preferably, the process of the present invention further comprises the steps of:
(iv) preferably, preparing a slurry from the mixture of step (iii) and subjecting the slurry to conditions of shear to produce an emulsion of said mixture, and preferably forming a layer of the emulsion;
(v) heating the mixture of step (iii), or where conducted step (iv), to an internal temperature of at least 70° C., preferably at least about 80° C., preferably no more than about 105° C., preferably wherein the duration of heating is at least 30 seconds, preferably from about 1 to about 60 minutes; and
(vi) forming discrete pieces of said food product, for instance by cutting or shredding the product of step (iv).

It will be appreciated that said discrete pieces of food product are preferably pieces of reconstituted animal material. Thus, the denatured zein protein is preferably incorporated into the food product (preferably a wet pet food product) in the form of reconstituted animal material comprising the denatured zein protein and animal protein. Thus, the process described herein preferably comprises the preparation of reconstituted animal material comprising denatured zein protein and animal protein.

The denatured zein protein is preferably used or present in an amount such that said discrete pieces of food product, or said reconstituted animal material, preferably comprises from about 1 wt % to about 20 wt %, preferably no more than 15 wt %, preferably no more than 10 wt %, of said denatured zein protein, by total dry weight of the discrete pieces of food product or reconstituted animal material.

In the preferred process described above, said slurry preferably comprises from about 50 to about 95 wt % (preferably from about 60 to about 90 wt %, preferably from about 65 to about 90 wt %) of the animal protein source.

The emulsification of the slurry may be performed in any conventional equipment, for instance a bowl chopper, or meat grinders, including rotating knives and die-plate combinations comprising holes of a defined diameter (for instance from about 0.5 mm to about 10 mm) through which the material passes. Optionally, the resulting material may then be transferred to a mixer where water, dry ingredients and liquid ingredients may be added.

The layer of emulsion formed in the process may take the form of, for instance, a sheet, a slab, a ribbon or rope.

The emulsion is suitably heated to an internal temperature of at least 70° C., preferably at least 75° C., preferably at least 80° C., and typically no more than about 105° C. The duration of heating is at least 30 seconds, preferably from about 1 to about 60 minutes. The heating of the layer of emulsion is suitably conducted in a steam tunnel.

The layer of emulsion is suitably heated from above by bringing steam into direct contact with the layer of emulsion and/or from below by applying steam to the underside of a continuous belt carrying said layer. Preferably, the emulsion is cooked in a steam tunnel, typically comprising a conveyor system (such as a conveyor belt), which blanches or cooks the emulsion with saturated or super-heated steam injected from above and/or below, thereby exposing the emulsion to a continual and even application of steam to ensure it is cooked thoroughly and set. The emulsion may be in the form of individual chunks during the heating step, but typically cutting into chunks is performed after the heating step.

As used herein, the term “emulsion” refers to a thick mixture of water and other substances derived from raw materials, such as meat or meat by-products. These “emulsions” are dispersions of fat particles and air bubbles in a complex phase composed of water, solubilized meat protein, cellular components and other ingredients. The emulsions may also be referred to as a meat “batter” or a meat “slurry”. Such terms are well understood in the art and are used interchangeably. Typically, the emulsions comprise a continuous phase which is an aqueous medium comprising soluble proteins, soluble muscle constituents, segments of muscle fibres, connective tissue fibres, bones, etc., and optionally further additives conventional in the art, including materials of plant origin, such as starches and/or fibres, and minerals.

Other methods to form the reconstituted animal material include the high moisture extrusion techniques described in WO-00/69276-A. Another suitable process for making the reconstituted animal material is described in U.S. Pat. No. 4,247,562.

A particular advantage of the present invention is the ability to use standard processing and equipment to form the reconstituted animal material.

The total protein content of the reconstituted animal material is preferably in an amount in the range of from about 5 to about 40 wt %, preferably at least about 10 wt %, preferably at least about 15 wt %, and typically no more than about 36 wt %, and preferably from about 25 wt % to about 36 wt %.

In the reconstituted animal material, or discrete pieces of food product, the protein fraction is preferably made up of at least 2 wt %, preferably at least about 3 wt %, preferably at least about 5 wt %, preferably no more than about 20 wt %, preferably no more than about 15 wt %, and typically no more than about 10 wt %, of denatured zein protein, by total dry weight of the protein fraction of the reconstituted animal material, or discrete pieces of food product. Preferably, the protein fraction is made up of at least 20 wt %, preferably at least 30 wt %, preferably at least about 40 wt %, and typically no more than about 80 wt %, typically no more than about 70 wt %, of animal protein, by total dry weight of the protein fraction of the reconstituted animal material, or discrete pieces of food product. Preferably, said animal protein is not protein derived from the functional organs of an animal as described above. Said protein fraction may further comprise protein derived from the egg of an animal, or otherwise derived from an animal, for instance casein or whey. Preferably, the protein fraction of the reconstituted animal material, or discrete pieces of food product, contains denatured zein protein in an amount which is less than the amount of animal protein in said protein fraction.

The fat content of the reconstituted animal material is preferably less than about 15 wt %, preferably no more than about 13 wt %, preferably no more than about 12 wt %, preferably no more than about 10 wt %, preferably no more than about 8 wt %, preferably at least about 2 wt %, preferably at least about 4 wt %. The term “fat” as used herein refers to esters of fatty acids such as triglycerides, diglycerides, monoglycerides and phospholipids. The fat preferably contains at least 50 wt %, more preferably at least 70 wt % of triglycerides. The fat may suitably contain animal fat, vegetable oil, marine oil and combinations thereof. Typically, the fat contains at least 10 wt %, more preferably at least 30 wt % and most preferably at least 50 wt % of an animal fat. The animal fat preferably originates from an animal selected from cattle, pigs, sheep, goat, poultry, fish and combinations thereof.

The water content of the reconstituted animal material is typically up to about 75 wt %, or up to about 65 wt %, and typically at least about 20 wt % or at least about 30 wt % or at least about 40 wt % or at least about 50 wt %, and preferably in the range of from about 50 to about 55 wt %, by total weight of the reconstituted animal material.

The fibre and carbohydrate content of the reconstituted animal material is typically up to about 20 wt %, by total weight of the reconstituted animal material. Preferably, the reconstituted animal material comprises no more than about 10 wt % fibre, preferably no more than about 5 wt %, preferably no more than about 2 wt %, typically no more than about 1 wt %, and preferably at least about 0.5 wt %, by total weight of the reconstituted animal material.

The reconstituted animal material typically exhibits a density of from about 0.8 to about 1.2 g/mL.

The size of the reconstituted animal material will vary and depends on the animal that is to consume the pet food and/or the format of the pet food. The longest dimension of the reconstituted animal material is typically from about 5 mm to about 200 mm, preferably at least about 10 mm, preferably no more than about 150 mm. Where the reconstituted animal material is a chunk suitable for a chunk-in-sauce product, as described hereinbelow, the longest dimension is preferably no more than about 50 mm, more preferably no more than about 40 mm, more preferably no more than about 30 mm, and in a preferred embodiment from about 5 mm to 25 mm, preferably from about 13 to about 20 mm.

The reconstituted animal material may also be referred to as a “meat analogue”. Advantageously, and as noted above, the reconstituted animal material produced by the process of the present invention preferably comprises a blended proteinaceous matrix or network of animal protein and denatured zein protein. The animal protein may also be denatured. Also as noted above, the blended proteinaceous matrix or network is preferably essentially homogeneous.

The term “pet food” as used herein refers to a food composition designed for ingestion by a pet. The wet pet food provided herein is preferably a nutritionally balanced food product to provide a pet with all the essential nutrients it needs in the appropriate quantities.

The pet food may be a pet food providing health and/or nutrition benefits to the pet, e.g. weight management pet foods, satiety pet foods and/or pet foods capable of improving renal function in the pet.

The wet pet food product and the components used therein are selected for consumption by a pet and are not intended for consumption by humans. The term “pet” as used herein preferably refers to a domestic animal, preferably a companion animal, particularly cats or dogs.

The wet pet food may be a loaf (or pate) product. As noted above, such products are normally in the form of a single piece of reconstituted animal material packaged in a container, such as a can, a pouch or a tray. Typically, these shaped pieces of reconstituted animal material have a piece volume of from about 20 to about 2,000 cm³, more preferably from about 40 to about 1,500 cm³, for instance from about 500 to about 1200 cm³. After packaging and sealing, the aforementioned product is preferably sterilised within the package, e.g. by retort sterilisation.

Alternatively, the wet pet food is a chunk-in-sauce product, as described herein above. The term “sauce” as used herein encompasses gravies, jellies and mousses, and preferably refers to a composition in the form of a fluid, a paste, a gel or a mousse. The sauce comprises a liquid carrier, such as water, fats or oils. Preferably the composition is an aqueous composition. A chunks-in-sauce product is prepared by combining the pieces of reconstituted animal material with a sauce, packaging the combination, sealing in the package and sterilising the package, e.g. by retort sterilisation. The pieces of reconstituted animal material may be added to the packaging while the sauce is poured over the pieces, for instance a heated sauce which allows the pieces to warm up and trapped gases to be expelled prior to sealing the packaging. Alternatively, ingredients are added to the reconstituted animal material and packaged, where the ingredients, in the usual sterilisation process, result in the formation in the package of the sauce mixed with the reconstituted animal material.

Sealing of the packaging may be and preferably is conducted using vacuum-sealing.

Retort sterilisation is preferably conducted at a retorting temperature in the range from about 115° C. to about 130° C., preferably for approximately 20 to 120 minutes, in order to produce a commercially sterile product.

The packaging may suitably be a can (or tin) or jar (e.g. glass) or otherwise a plastic, metal, foil pouch, or flexifoil.

The wet pet food product may comprise up to 100 wt % of the reconstituted animal material, and preferably at least about 5 wt % of the reconstituted animal material, by total weight of the wet pet food product. In other words, the wet pet food product may comprise, consist essentially or consist of the reconstituted animal material. A loaf product suitably consists essentially or consists of the reconstituted animal material. A chunks-in-sauce product preferably comprises a ratio of reconstituted animal material:sauce of from about 20:80 to about 90:10, preferably at least about 30:70, preferably at least about 40:60, preferably at least about 50:50, preferably at least about 60:40.

The sauce component of the wet pet food product may be any suitable sauce conventional in the art of wet pet food, and typically exhibits a water content of at least about 80 wt %, typically at least about 90 wt %, typically no more than about 98 wt %, by total weight of the sauce. The sauce typically comprises a thickening agent which is used to control its consistency. Thickeners or gelling agents that may be used to prepare the sauce include carrageenan, xanthan, guar gum, cassia gum, starch, gelatine, CMC, LBG, TARA gum and combinations thereof. The sauce is typically a coating which surrounds the reconstituted animal material.

The sauce may contain additional ingredients conventionally used in the manufacture of wet pet food products, such as fat, antioxidants, carbohydrates, seasoning, colorants, flavouring, minerals, preservatives, vitamins, emulsifiers, farinaceous materials and combinations thereof. The sauce preferably comprises one or more flavouring agents.

Flavourings impart particular taste or smell and may be derived from natural ingredients or artificially created. Flavourings may include one or more products of the Maillard reaction. Flavouring agents such as beef flavour and meat flavour can be used in amounts sufficient to impart the desired flavour.

The total protein content of the chunk-in-sauce wet pet food product is preferably in the range of from about 5 to about 20 wt %, preferably from about 5 to about 10 wt %, by total weight of the product.

The total fat content of the chunk-in-sauce wet pet food product is preferably no more than about 15 wt %, preferably no more than about 10 wt %, preferably no more than about 7 wt %, preferably at least about 2 wt %, by total weight of the product.

The total fibre content of the chunk-in-sauce wet pet food product is preferably no more than about 5 wt %, preferably no more than about 2 wt %, preferably no more than about 1 wt %, preferably at least about 0.1 wt %, by total weight of the product.

The water content of the chunk-in-sauce wet pet food product is typically at least about 70 wt %, preferably at least about 75 wt %, and preferably at least about 80 wt %, preferably no more than about 95 wt %, preferably no more than about 90 wt %, by total weight of the product.

Preferably, the amount of fines (i.e. solid material having a longest dimension of no more than 3 mm) in the chunk-in-sauce wet pet food product is no more than about 10 wt %, preferably no more than about 8 wt %, preferably no more than about 5 wt %, preferably no more than about 3 wt %, by total weight of the wet pet food product.

In general terms, the denatured zein protein is present in the food product in an amount such that the food product preferably comprises at least about 1 wt %, preferably at least about 2.5 wt %, preferably at least about 5 wt %, and preferably no more than about 20 wt %, preferably no more than about 15 wt %, preferably no more than about 10 wt %, of denatured zein protein by total dry weight of the food product.

According to a second aspect of the invention, there is provided a process for preparing reconstituted animal material, preferably as described hereinabove, said process comprising the steps of:
(i) providing a composition comprising zein protein;
(ii) treating the composition from step (i) to denature said zein protein to provide a composition comprising denatured zein protein;
(iii) mixing said composition comprising denatured zein protein with an animal protein source;
(iv) preferably, preparing a slurry from said mixture and subjecting the slurry to conditions of shear to produce an emulsion of said mixture, and preferably forming a layer of the emulsion;
(v) heating the mixture to an internal temperature of at least 70° C. (preferably at least about 80° C.); and
(vi) forming discrete pieces of reconstituted animal material.

According to a third aspect of the invention, there is provided a process for preparing a wet pet food product comprising reconstituted animal material comprising denatured zein protein and animal protein, preferably as described hereinabove, said process comprising the steps of:
(i) providing a composition comprising zein protein;
(ii) treating the composition from step (i) to denature said zein protein to provide a composition comprising denatured zein protein;
(iii) mixing said composition comprising denatured zein protein with an animal protein source;
(iv) preferably, preparing a slurry from said mixture and subjecting the slurry to conditions of shear to produce an emulsion of said mixture, and preferably forming a layer of the emulsion;
(v) heating the mixture to an internal temperature of at least 70° C. (preferably at least about 80° C.);
(vi) forming discrete pieces of reconstituted animal material;
(vii) optionally combining said reconstituted animal material with a sauce;
(viii) inserting said reconstituted animal material and optional sauce into packaging; and
(ix) sealing and sterilizing the package to provide a packaged wet pet food product.

According to a fourth aspect of the invention, there is provided the use of denatured zein protein as a protein source in a food product or in the manufacture of said food product. In a preferred embodiment, said use is the use of denatured zein protein as a partial or full replacement for protein derived from functional animal organs (such as liver) in a food product. In a further embodiment, said use of is the use of denatured zein protein as a partial or full replacement for animal protein and/or wheat gluten in a food product.

According to a fifth aspect of the invention, there is provided a food product, particularly a pet food product, particularly a wet pet food product, comprising a blended proteinaceous matrix or network of animal protein and denatured zein protein. Preferably, said food product is prepared by a process as described hereinabove.

According to a sixth aspect of the invention, there is provided a reconstituted animal material comprising a blended proteinaceous matrix or network of animal protein and denatured zein protein. Preferably, said reconstituted animal material is prepared by a process as described hereinabove.

According to a seventh aspect of the invention, there is provided a dry or semi-moist pet food product, i.e. a product exhibiting less than 20 wt % moisture or from 20 to 50 wt % respectively, comprising or consisting essentially or consisting of the reconstituted animal material described herein. The reconstituted animal material may also be incorporated into pet food products generally, including supplements, snacks and treats, such as a dry kibble product.

It will be appreciated that the detailed disclosure and preferences of the first aspect of the invention as described above are also applicable to each of the second to seventh aspects of the invention.

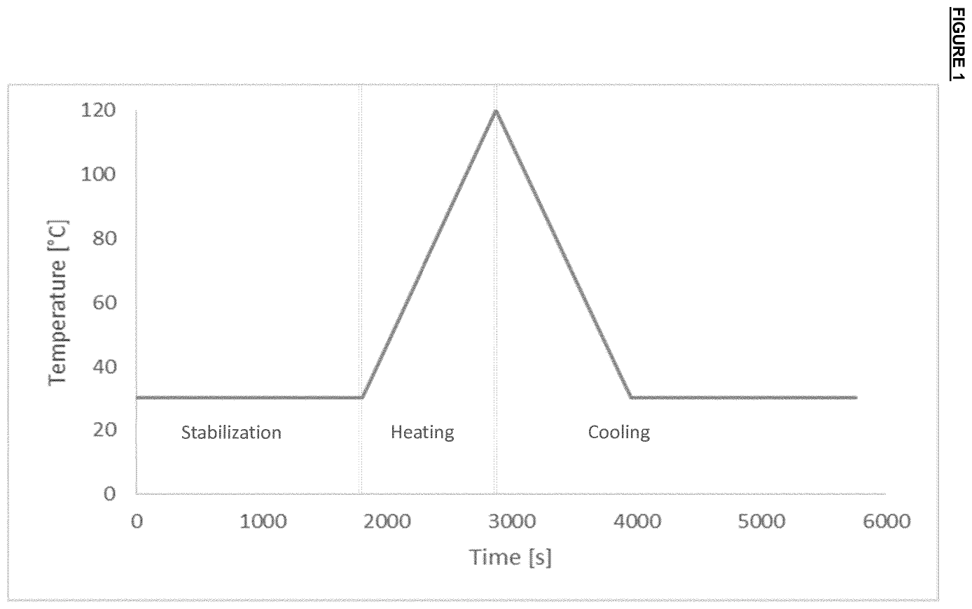

The materials described herein are suitably characterised using the measurement methods described below.
(i) The degree of denaturation is measured by differential scanning calorimetry (DSC), using the following procedure. Approximately 50 mg of a zein and water mixture (65:35 zein powder:water, w/w) is weighed into a 120 μL aluminium sample crucible, sealed and analysed in a micro-calorimeter (SETARAM Instrumentation, Caluire, France), using as a reference a crucible containing the same amount of water as contained in the sample crucible. The scan is performed using the temperature profile shown in FIG. 1 at a scanning rate of 5° C./min. Curve manipulation and integration is performed by selecting the data from the first ramp (30° C. to 120° C.) and then cutting to the signal from 50° C. to 100° C. The curve is integrated using the sigmoidal tangential mode. The degree of denaturation is calculated by comparing the heat flow of the denatured samples with native protein with over the width of the denaturation peak.
(ii) Particle size is measured by laser light diffraction, in particular by static light scattering. A suitable instrument is a Mastersizer (e.g. a 2000) available from Malvern Instruments Ltd. The particles are mixed with water (20% w/w) for the analysis.
(iii) Rheology. The standing viscosity, pumping viscosity and high-shear viscosity is measured in a viscometer (Brookfield DV1, AMETEK, Lorch, Germany).
(iv) Texture Profile Analysis is conducted on a TA.TX plus texture analyser (Stable Micro Systems, Surrey, UK), equipped with a 5 kg probe, and using a double compression method. The chunk is first compressed to 50% of its original chunk height, the pressure released, and the chunk then compressed a second time to 50% of its chunk height. The following parameters are measured:
   Hardness: the peak force during the first compression
   Adhesiveness: the negative work between the two cycles
   Cohesiveness: describes how well the product withstands a second deformation relative to its resistance under the first deformation; calculated as the area of work during the second compression divided by the area of work during the first compression
   Chewiness: Hardness×Cohesiveness×Springiness (The parameter “springiness” is measured by squeezing the chunk and then releasing it; the chunk “bounces” back upon release and attains a certain height; this new height, divided by the original height is the “springiness”).
(v) Retort Stability of the reconstituted animal material or discrete piece of pet food is measured by incorporating it into wet pet food. Chunks are mixed with an aqueous gravy (50:50, w/w), sealed in a can or pouch, sterilised at greater than 120° C. for 10-120 mins, and then left under ambient conditions for a maturation time of two weeks. If, on opening the can or pouch, the chunks are visible as separate pieces, then the material is considered as retort-stable in excess water/moisture. If the procedure results in a pate or paste, then the material is considered as retort-unstable in the presence of excess water/moisture

The present invention is further illustrated below with reference to the following non-limiting examples.

### EXAMPLES

### Example 1a

Maize gluten (zein) powder having a protein content of 60 wt % was mixed with water in the mixing chamber of a multi-zone twin-screw extruder, to provide a mixture having a water content of 35 wt % (i.e. 65:35 maize gluten powder:water). The feed rate of water and zein powder was 39 kg/h. The extruder was operated with a screw speed of 300 rpm. The extruder had a heating zone and a cooling zone. The maximum temperature of the heating zone was 140° C. The zein/water mixture was passed into the heating zone of the extruder to denature the zein protein, and the denatured zein protein was then passed into the cooling zone of the extruder where it was cooled at successive temperatures to 50° C. and 30° C. The particle size and the moisture content after extrusion of the product were analysed, and the results are shown in Table 1. The Control in Table 1 is native zein protein, i.e. without denaturation.

### Example 1b

The procedure of Example 1a was repeated except that the water was replaced with a 0.5M aqueous solution of NaOH, to provide a 65:35 mixture of maize gluten powder:aqueous solution.

### Example 1c

The procedure of Example 1a was repeated except that the water was replaced with a 50:50 mixture of glycerol:water, to provide a 65:35 mixture of maize gluten powder:glycerol/water as before.

TABLE 1

| | Particle Size (D90; μm) | Moisture Content (%) |
|---|---|---|
| Control | 800 | 9.0 |
| Example 1a | 535 | 34.0 |
| Example 1b | 473 | 32.9 |
| Example 1c | 724 | 18.4 |

The resulting denatured zein protein was dispersible in water at room temperature, and able to be combined with an animal protein to form a reconstituted animal material in a meat emulsion, as described below.

### Examples 2a, 2b and 2c

A series of experiments was conducted, in which the denatured zein protein described in each of Examples 1a, 1b and 1c above was used as an ingredient in the manufacture of a reconstituted animal material in accordance with conventional techniques and using a conventional recipe, the output being chunks having dimensions of about 7 mm×7 mm×7 mm. A Reference Example using the conventional recipe was also made by adding porcine liver to approximately 830 g of meat emulsion, such that the liver was present at 17 wt % of the dry matter of the reconstituted animal material. For each sample, the denatured zein protein (DZP) was incorporated into the reconstituted animal material at a level of 10 wt %, by total weight of the reconstituted animal material. Recipes were calculated so that every recipe retains the same amount of dry solids compared to the existing recipe. Thus, additional water was included in order to keep the moisture level of the liver replacement at the same level as the liver in the original recipe i.e. at 78.35%. The basis of this calculation is 1 kg emulsion.

TABLE 1
Recipes

| | DZP in | Liver in | Liver | DZP | Water | Moisture |
|---|---|---|---|---|---|---|
| Example | recipe (%) | recipe (%) | (g) | (g) | added (g) | (g) |
| Reference | 0 | 17 | 170 | 0 | 0 | 78.35 |
| Example 2 | 10 | 7 | 70 | 39.36 | 60.64 | 78.35 |

The rheology of the emulsions was analysed and each of the emulsions of Examples 2a, 2b and 2c exhibited a viscosity of from about 6×10⁴ to 9×10⁴ cP, which was within the acceptable and workable limits suitable for the downstream processing equipment and comparable with the viscosity of the emulsion of the Reference Example.

A Comparative Example emulsion was prepared in the same way as described above but using native zein protein (i.e. not denatured). The viscosity of this emulsion was significantly greater that the viscosities of Examples 2a, 2b and 2c and the Reference Example, at about 1.1×10⁵ cP.

After mixing of the ingredients, the emulsions were cooked in a steam oven and the chunks cut into regular 7×7×7 mm sizes. Upon visual inspection, the freshly made chunks of each of Examples 2a, 2b and 2c exhibited excellent form and structure, and were similar in appearance to the conventional recipe of the Reference Example. In contrast, the chunks of the Comparative Example exhibited dry regions where the zein protein had not mixed adequately with the rest of the emulsion.

The hardness of the fresh chunks was analysed and in all cases the chunks of Examples 2a, 2b and 2c exhibited a chunk hardness which was at least as hard as the Reference Example, and would hence be expected to perform at least as well as the Reference Example in terms of fines content.

The chunks (50 g) from each sample were placed into a pouch with water (50 g), and the pouch sealed and then retorted (sterilised) under conventional conditions. The pouch was maintained for two weeks at 25° C. After two weeks, the pouches were opened and the chunks inspected as before. In all cases, the mature chunks of Examples 2a, 2b and 2c exhibited excellent form and structure, and were similar in appearance to the conventional recipe of the Reference Example. No crumbling, stickiness or dryness was observed. This test represents an accelerated ageing test to gauge how the chunks behave in a conventional gravy or sauce when retorted and stored.

The freshly made and mature chunks were also tested by texture profile analysis (TPA) as described herein. The results show that the chunks of Example 2a, 2b and 2c exhibited hardness, adhesiveness, cohesiveness and chewiness which was substantially equivalent to, and within acceptable quality control limits for, the existing commercial product, as represented by the Reference Example, in respect of both the fresh chunk and the mature chunk.

### Examples 3a and 3b

The procedure of Example 1a was repeated but replacing a portion of the zein protein with a water-dispersible protein which had greater hydrophilicity than the zein protein. In Example 3a the zein protein was blended with gelatin in a ratio of 95:5, and in Example 3b the zein protein was blended with gelatin in a ratio of 90:10. The resulting mixture again had of protein:water ratio of 65:35. The presence of the gelation in the protein fraction resulted in a reduction in the particle size; for instance, the measured D90 value of the particulate material of Example 3b was 425 μm.

The micro-particulate denatured zein protein of Examples 3a and 3b were used to prepare emulsions and chunks in the same was as described above. In both instances, the freshly made chunks exhibited excellent form and structure upon visual inspection, and were similar in appearance to the conventional recipe of the Reference Example. The fresh and mature hardness of the chunks were analysed and comparable to the Reference Example in both cases.

### Examples 4a, 4b and 4c

The procedure of Example 1b was repeated but replacing a portion of the zein protein with gelatin, namely 5 wt % (Example 4a), 7.5 wt % (Example 4b) and 10 wt % (Example 4c). The resulting mixture had of ratio of protein:aqueous 0.5M NaOH solution of 65:35. The resultant micro-particulate denatured zein protein was used to prepare emulsions and chunks as described above. The viscosity of the emulsions and the chunk hardness of the fresh and matured chunks were all within acceptable limits and comparable with the Reference Example. Upon visual inspection, the chunks exhibited excellent form and structure, with even blending of the zein protein and similar appearance to the Reference Example. Example 4b and 4c in particular demonstrated excellent homogeneity.

### Example 5

The procedure of Example 1a was repeated except that liquid whey concentrate (LWC; approx. 6 wt % whey protein on a dry matter basis) was used as a hydrophilic plasticiser in place of the water, to provide a mixture of zein protein:LWC in a ratio of 65:35.

### Example 6

The procedure of Example 1a was repeated except that 50 wt % of the zein protein was replaced with whey protein isolate powder, to provide a mixture of zein protein, whey protein and water in a protein:water ratio of 65:35. The presence of the more hydrophilic whey protein in the protein fraction resulted in a significant reduction in the particle size; the measured D90 value of the particulate material of Example 6 was about 200 μm.

### Example 7

The procedure of Example 1b was repeated except that 50 wt % of the zein protein was replaced with whey protein isolate, to provide a mixture of zein protein, whey protein and 0.5M NaOH aqueous solution which had a protein:aqueous solution ratio of 65:35.

### Example 8

The procedure of Example 1b was repeated except that 1 wt % of the zein protein was replaced with gum Arabic, to provide a mixture of zein protein, gum Arabic and 0.5M NaOH aqueous solution which had a protein:aqueous solution ratio of 65:35.

The micro-particulate denatured zein protein of Examples 5, 6, 7 and 8 were used successfully to prepare emulsions and chunks, all of which demonstrated processability and product characteristics within acceptable quality control limits.

The results demonstrate that, unexpectedly, micro-particulate denatured zein protein is an excellent partial replacement for animal protein in pet food products.

1. A process for the preparation of a pet food product, said process comprising:
(i) providing a composition comprising zein protein;
(ii) treating the composition from step (i) to denature said zein protein to provide a composition comprising denatured zein protein; and
(iii) mixing said composition comprising denatured zein protein with animal protein to form said food product.

2. The process according to claim 1, wherein said pet food product is a wet pet food.

3. The process according to claim 1, wherein said pet food product comprises reconstituted animal material.

4. The process according to claim 1, wherein said pet food product comprises a blended proteinaceous matrix or network of animal protein and denatured zein protein.

5. The process according to claim 1, wherein the animal protein comprises ground animal material.

6. The process according to claim 1, further comprising:
(iv) preparing a slurry from the mixture of step (iii) and subjecting the slurry to conditions of shear to produce an emulsion of said mixture;
(v) heating the mixture of step (iii), or where performed step (iv), to an internal temperature of at least 70° C., wherein the duration of heating is at least 30 seconds; and
(vi) forming discrete pieces of said pet food product.

7. The process according to claim 1, wherein said treating step (ii) comprises an application of mechanical energy to denature said zein protein.

8. The process according to claim 1, wherein said treating step (ii) comprises passing said composition comprising zein protein through a twin-screw extruder.

9. The process according to claim 1, wherein said treating step (ii) is conducted at a temperature in the range of from about 100° C. to about 160° C.

10. The process according to claim 1, wherein said composition comprising zein protein of step (i) is in powder form.

11. The process according to claim 1, wherein prior to or during said treating step (ii) an aqueous medium is added to said composition comprising zein protein in amount such that the weight ratio of said composition to said aqueous medium is from about 70:30 to about 60:40.

12. (canceled)

13. The process according to claim 1, wherein said treating step (ii) comprises adjusting the pH of the composition to a pH of no more than 7.00.

14. The process according to claim 1, wherein said treating step (ii) avoids or substantially avoids the formation of gelled zein protein during the performance of said step (ii).

15. The process according to claim 1, wherein said denatured zein protein provided by step (ii) is in particulate form or micro-particulate form.

16. The process according to claim 15, wherein said denatured zein protein provided by step (ii) is in particulate form or micro-particulate form such that the particulate or micro-particulate forms are non-aggregated or substantially non-aggregated.

17. The process according to claim 1, wherein said denatured zein protein provided by step (ii) is in particulate form such that the particle size is no greater than a particle size of the native zein protein from which it is derived.

18. The process according to claim 1, wherein prior to or during treating step (ii), one or more water-dispersible material(s) is added to the composition comprising zein protein.

19. The process according to claim 18, wherein said one or more water-dispersible material(s) is selected from proteins, plant-derived proteins, hydrocolloids, or gums.

20. (canceled)

21. (canceled)

22. The process according to claim 1, wherein between steps (ii) and (iii) said composition comprising denatured zein protein is dried, collected and stored for subsequent use in said process for the preparation of a pet food product.

23. (canceled)

24. A process for preparing a wet pet food product, said process comprising:
(i) providing a composition comprising zein protein;
(ii) treating the composition from step (i) to denature said zein protein to provide a composition comprising denatured zein protein;
(iii) mixing said composition comprising denatured zein protein with an animal protein source;
(iv) preparing a slurry from said mixture and subjecting the slurry to conditions of shear to produce an emulsion of said mixture;
(v) heating the mixture to an internal temperature of at least 70° C.;
(vi) forming discrete pieces of reconstituted animal material;
(vii) optionally combining said reconstituted animal material with a sauce;
(viii) inserting said reconstituted animal material and optional sauce into packaging; and
(ix) sealing and sterilizing the package to provide a packaged wet pet food product.

25. (canceled)

26. (canceled)

27. (canceled)

28. (canceled)

29. (canceled)

30. (canceled)

31. (canceled)

32. (canceled)
